(19) United States
(12) Patent Application Publication
(10) Pub. No.: US 2026/0095866 A1
(43) Pub. Date: Apr. 2, 2026

(54) WAKE-UP SIGNAL MONITORING CONFIGURATION WITH DISCONTINUOUS RECEPTION OPERATIONS

(71) Applicant: QUALCOMM Incorporated, San Diego, CA (US)

(72) Inventors: Kazuki TAKEDA, Minato-ku (JP); Jelena DAMNJANOVIC, Del Mar, CA (US); Igor GUTMAN, Hod HaSharon (IL); Jung Ho RYU, Englewood Cliffs, NJ (US); Hemant SAGGAR, San Diego, CA (US); Tao LUO, San Diego, CA (US)

(21) Appl. No.: 19/338,896

(22) Filed: Sep. 24, 2025

Related U.S. Application Data
(60) Provisional application No. 63/701,920, filed on Oct. 1, 2024.

(51) Int. Cl. H04W 52/02; H04W 72/23; H04W 76/28

(52) U.S. Cl. CPC H04W 52/0235; H04W 72/23; H04W 76/28

(57) ABSTRACT

Various aspects of the present disclosure generally relate to wireless communication. In some aspects, a user equipment (UE) may detect that one or more communication operations on a main radio collide with a set of wake-up signal (WUS) monitoring occasions (MOs), such that an event criterion is satisfied. The UE may monitor, on the main radio, for a downlink control channel based at least in part on the event criterion being satisfied and without detection of a WUS. Numerous other aspects are described.

### CROSS-REFERENCE TO RELATED APPLICATION

This Patent Application claims priority to U.S. Provisional Ser. No. 63/701,920, filed on Oct. 1, 2024, entitled “LOW-POWER WAKE-UP SIGNAL MONITORING CONFIGURATION WITH DISCONTINUOUS RECEPTION OPERATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with wake-up signaling (WUS) monitoring configuration with discontinuous reception (DRX) operations.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include detecting that one or more communication operations on a main radio collide with a set of wake-up signal (WUS) monitoring occasions (MOs), such that an event criterion is satisfied. The method may include monitoring, on the main radio, for a downlink control channel based at least in part on the event criterion being satisfied and without detection of a WUS.

Some aspects described herein relate to a method of wireless communication performed by a network node. The method may include detecting that one or more communication operations, associated with reception by a main radio of a UE, collide with a set of WUS MOs, such that an event criterion is satisfied. The method may include transmitting, for reception on the main radio, a downlink control channel based at least in part on the event criterion being satisfied and without transmission of a WUS in a WUS MO, of the set of WUS MOs, corresponding to the downlink control channel.

Some aspects described herein relate to a non-transitory computer-readable medium that stores a set of instructions for wireless communication by a UE. The set of instructions, when executed by one or more processors of the UE, may cause the UE to detect that one or more communication operations on a main radio collide with a set of WUS MOs, such that an event criterion is satisfied. The set of instructions, when executed by one or more processors of the UE, may cause the UE to monitor, on the main radio, for a downlink control channel based at least in part on the event criterion being satisfied and without detection of a WUS.

Some aspects described herein relate to a non-transitory computer-readable medium that stores a set of instructions for wireless communication by a network node. The set of instructions, when executed by one or more processors of the network node, may cause the network node to detect that one or more communication operations, associated with reception by a main radio of a UE, collide with a set of WUS MOs, such that an event criterion is satisfied. The set of instructions, when executed by one or more processors of the network node, may cause the network node to transmit, for reception on the main radio, a downlink control channel based at least in part on the event criterion being satisfied and without transmission of a WUS in a WUS MO, of the set of WUS MOs, corresponding to the downlink control channel.

Some aspects described herein relate to a UE for wireless communication. The UE may include one or more memories and one or more processors coupled to the one or more memories. The one or more processors may be configured to detect that one or more communication operations on a main radio collide with a set of WUS MOs, such that an event criterion is satisfied. The one or more processors may be configured to monitor, on the main radio, for a downlink control channel based at least in part on the event criterion being satisfied and without detection of a WUS.

Some aspects described herein relate to a network node for wireless communication. The network node may include one or more memories and one or more processors coupled to the one or more memories. The one or more processors may be configured to detect that one or more communication operations, associated with reception by a main radio of a UE, collide with a set of WUS MOs, such that an event criterion is satisfied. The one or more processors may be configured to transmit, for reception on the main radio, a downlink control channel based at least in part on the event criterion being satisfied and without transmission of a WUS in a WUS MO, of the set of WUS MOs, corresponding to the downlink control channel.

Some aspects described herein relate to an apparatus for wireless communication. The apparatus may include means for detecting that one or more communication operations on a main radio collide with a set of WUS MOs, such that an event criterion is satisfied. The apparatus may include means for monitoring, on the main radio, for a downlink control channel based at least in part on the event criterion being satisfied and without detection of a WUS.

Some aspects described herein relate to an apparatus for wireless communication. The apparatus may include means for detecting that one or more communication operations, associated with reception by a main radio of a UE, collide with a set of WUS MOs, such that an event criterion is satisfied. The apparatus may include means for transmitting, for reception on the main radio, a downlink control channel based at least in part on the event criterion being satisfied and without transmission of a WUS in a WUS MO, of the set of WUS MOs, corresponding to the downlink control channel.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a wakeup radio (WUR) and a wakeup signal (WUS), in accordance with the present disclosure.

FIG. 4 is a diagram illustrating an example of a discontinuous reception (DRX) configuration, in accordance with the present disclosure.

FIGS. 5A-5D are diagrams illustrating examples associated with WUS monitoring configuration with DRX operations, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication system may provide for communications between network nodes and a user equipment (UE). These communications may consume some amount of power. For example, a UE may consume a lower amount of power while in a low power state (such as while not connected to a network or while waiting for paging from the network), and may consume a higher amount of power while in a full power state (such as while actively communicating with a network node or while monitoring for control information from the network). Certain components of the UE may consume a significant amount of power. For example, a radio of the UE, which may support bidirectional communication (such as both transmission and reception), multi-layer communication, or larger bandwidths (such as a communication bandwidth of the UE), may consume power while active, such as in the course of communicating or monitoring for control information.

Some techniques provide power savings at the UE by limiting the amount or ratio of time in which a radio is active, relative to the amount of time in which the radio is inactive or powered down. For example, a connected mode discontinuous reception (DRX) (C-DRX) cycle may provide off durations (sometimes referred to as inactive times or sleep durations) in which the radio is inactive, and on durations (sometimes referred to as active times or wake durations) in which the radio is active. The UE may monitor for a physical downlink control channel (PDCCH) (or another control channel or data channel) during an on duration, and may extend the on duration if a PDCCH communication is received, which facilitates further communication in accordance with the PDCCH communication. Thus, power consumption of the main radio may be reduced by reducing the amount of time in which the main radio is active and/or monitoring for a PDCCH communication.

While the C-DRX cycle reduces power consumption at the UE and the network, further power savings may be desirable, particularly in 5G, 6G, and similar radio access technologies (RATs) where beamforming and high-frequency communication cause increased power consumption relative to other RATs. To achieve further power savings, a UE may include or be associated with a second, wake-up radio (WUR), which may also be referred to as a “low-power wakeup radio” or an “LP-WUR.” Relative to a non-LP-WUR (e.g., a main radio (MR) of the UE), the LP-WUR may have reduced power consumption. For example, the LP-WUR may be configured with a reduced bandwidth, reduced processing capabilities, or other reduced capabilities, relative to a main radio, which facilitate operation with reduced power consumption. In one particular example, the LP-WUR may be configured to use an envelope detector type of receiver architecture, with on-off keying (OOK) modulation, to enable a UE to perform signaling monitoring with low power consumption.

The LP-WUR may facilitate indication, from the network, for the UE to exit a low power state, such as by waking up the main radio. For example, while the main radio is in a low power state, the LP-WUR may receive a signal referred to as a wakeup signal (WUS), which may also be referred to as a “low-power wakeup signal” or an “LP-WUS” and may trigger the main radio to exit the low power state and may trigger a UE to transfer from an idle mode to an active mode to receive PDCCH paging. In another example, when a UE is operating in a connected mode, the LP-WUS may trigger UE PDCCH monitoring. In some configurations, the LP-WUS/LP-WUR can be implemented in conjunction with a C-DRX cycle, such that the main radio may skip an on duration if the LP-WUR has not received an LP-WUS in association with (e.g., before) the on duration, thereby further reducing power consumption relative to waking up in an on duration in which the UE will not receive a PDCCH communication.

When LP-WUS transmission is used with DRX operations, a UE may monitor for an LP-WUS that triggers the UE to start an on duration timer, such as drx-onDurationTimer, for a DRX cycle. A DRX active time, associated with the on duration timer, may be extended when a condition is satisfied. For example, when the UE receives a PDCCH communication during the DRX active time, the UE may reset an inactivity timer, such as drx-InactivityTimer, and may continue in the DRX active time until the inactivity timer expires. However, when the UE extends the DRX active time, monitoring for PDCCH communications in the DRX active time may collide with (e.g., occur concurrently with) LP-WUS monitoring occasions (MOs) for receiving an LP-WUS associated with triggering a next DRX active time. In other words, the UE may extend a first DRX active time, which may cause the UE to fail to receive an LP-WUS associated with indicating that the UE is to be active for a second DRX active time. This may result in the UE transitioning to a DRX inactive time and failing to receive one or more communications that are directed to the UE.

Various aspects relate generally to WUS monitoring configuration with DRX operations. Some aspects more specifically relate to handling scenarios in which a WUS MO overlaps with another communication operation, such as PDCCH monitoring of a DRX active time. In some aspects, the UE may, when one or more WUS MOs collide with another communication operation, monitor for a PDCCH without having received a WUS associated with triggering monitoring. In other words, when the UE extends a first DRX active time such that PDCCH monitoring in the first DRX active time overlaps with WUS MOs associated with triggering a second DRX active time, the UE may monitor for a PDCCH in the second DRX active time despite not having received a WUS associated with triggering PDCCH monitoring in the second DRX active time. In some aspects, the UE may trigger PDCCH monitoring based on one or more WUS MOs colliding with a measurement gap, a multicast broadcast service (MBS) DRX active time, or a sidelink DRX active time, among other examples. In some aspects, the UE may receive signaling conveying a parameter associated with configuring the UE to perform PDCCH monitoring even when a WUS MO is not received (e.g., as a result of collisions between WUS MOs and another communication operation). For example, the UE may receive signaling indicating a quantity of colliding WUS MOs that the UE may have before triggering PDCCH monitoring. In some aspects, the UE may be configured for PDCCH monitoring during a period scheduled for another communication operation, such as an MBS DRX active time or a sidelink DRX active time (e.g., when one or more WUS MOs collide with other communication operations).

Particular aspects of the subject matter described in this disclosure can be implemented to realize one or more of the following potential advantages. In some examples, the described techniques can be used to monitor for a downlink control channel, such as a PDCCH. In some examples, by monitoring for a downlink control channel without detection of a WUS, the described techniques can be used to avoid missed communications.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

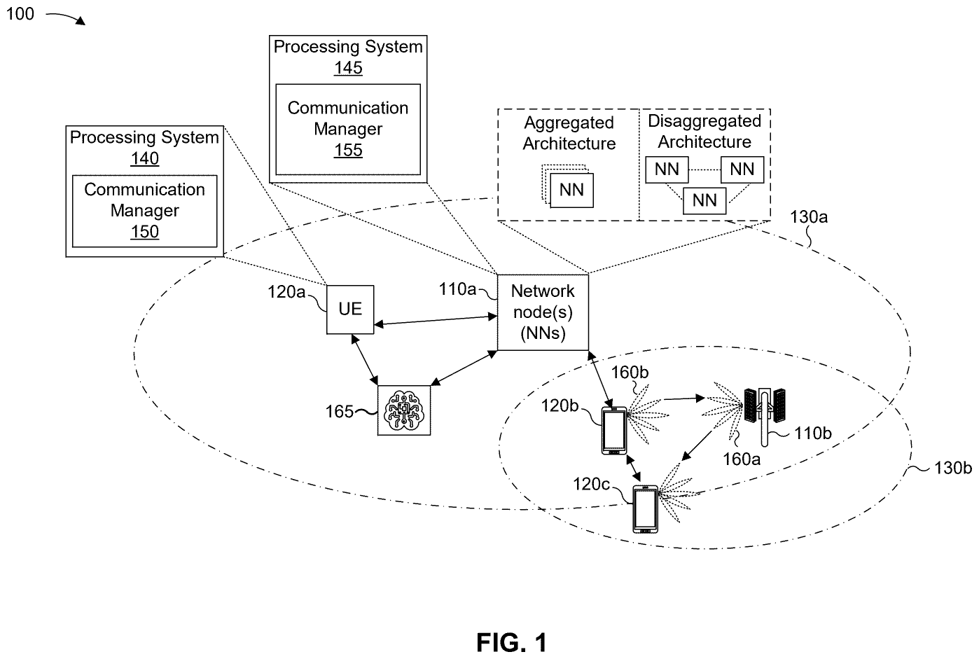

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

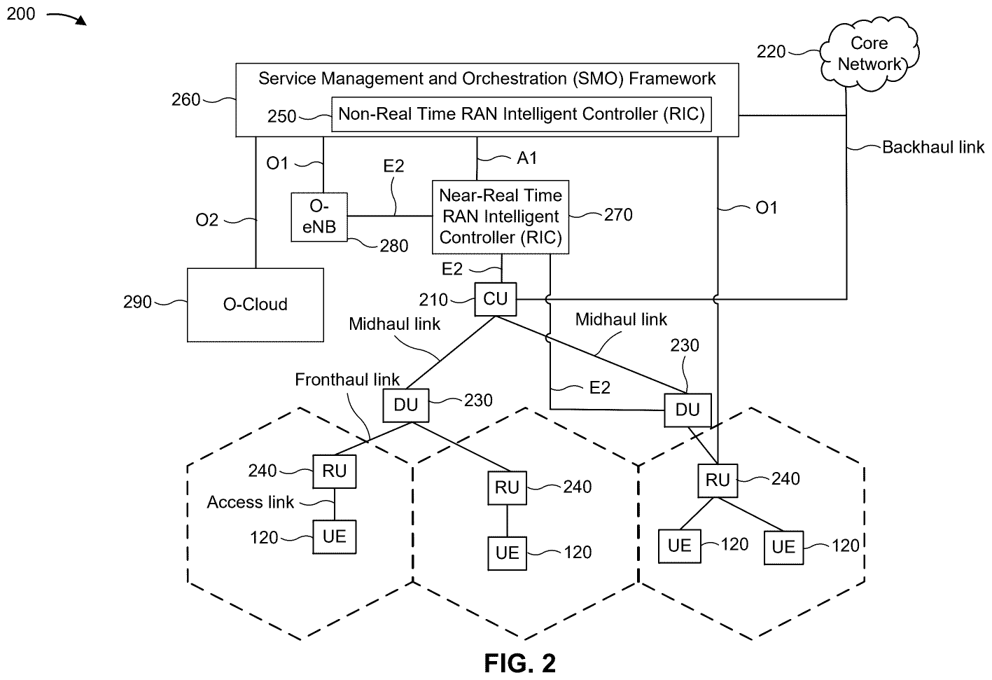

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

As described above, a UE 120 may achieve additional power savings in connection with a DRX mode by using an LP-WUR to monitor for an LP-WUS. For example, the LP-WUR may use reduced power resources relative to a main radio, so a UE 120 may achieve power savings by using the LP-WUR to monitor for a wake-up signal that triggers a transition to an active mode (and use of the main radio) relative to using the main radio to monitor for a signal that triggers a transition to an active mode. An LP-WUR may be used, by a UE 120, in connection with a DRX mode or separate from a DRX mode (e.g., to reduce power consumption associated with other monitoring procedures).

As described above, a substantial proportion of power utilization, in a wireless communication network such as the wireless communication network 100, may occur in connection with operations of the network nodes 110. For example, a network node 110 may transmit an LP-WUS at a maximum power in a cell to ensure that a UE 120 in the cell (e.g., at a cell edge) can successfully receive the LP-WUS using an LP-WUR. As described in more detail herein, some wireless communications networks 100 may introduce SFN-type LP-WUS signaling to reduce power consumption from operations of the network nodes 110. For example, by transmitting an LP-WUS communication, via a set of transmitters for a set of cells (e.g., transmitters of one or more network nodes 110), each transmitter may transmit at less than the maximum power in the cell. Based on each transmitter transmitting a coordinated signal in the same resources, inter-cell interference may cause a gain to the coordinated signal at cell edges (e.g., rather than causing noise), which enables a threshold level of signal strength (and detection of the LP-WUS communication by an LP-WUR of a UE 120) with the reduced transmit power and the reduced power consumption.

In some aspects, the UE 120 may include a communication manager 150. As described in more detail elsewhere herein, the communication manager 150 may detect that one or more communication operations on a main radio collide with a set of WUS MOs, such that an event criterion is satisfied; and monitor, on the main radio, for a downlink control channel based at least in part on the event criterion being satisfied and without detection of a WUS. Additionally, or alternatively, the communication manager 150 may perform one or more other operations described herein.

In some aspects, the network node 110 may include a communication manager 155. As described in more detail elsewhere herein, the communication manager 155 may detect that one or more communication operations, associated with reception by a main radio of a UE, collide with a set of WUS MOs, such that an event criterion is satisfied; and transmit, for reception on the main radio, a downlink control channel based at least in part on the event criterion being satisfied and without transmission of a WUS in a WUS MO, of the set of WUS MOs, corresponding to the downlink control channel. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

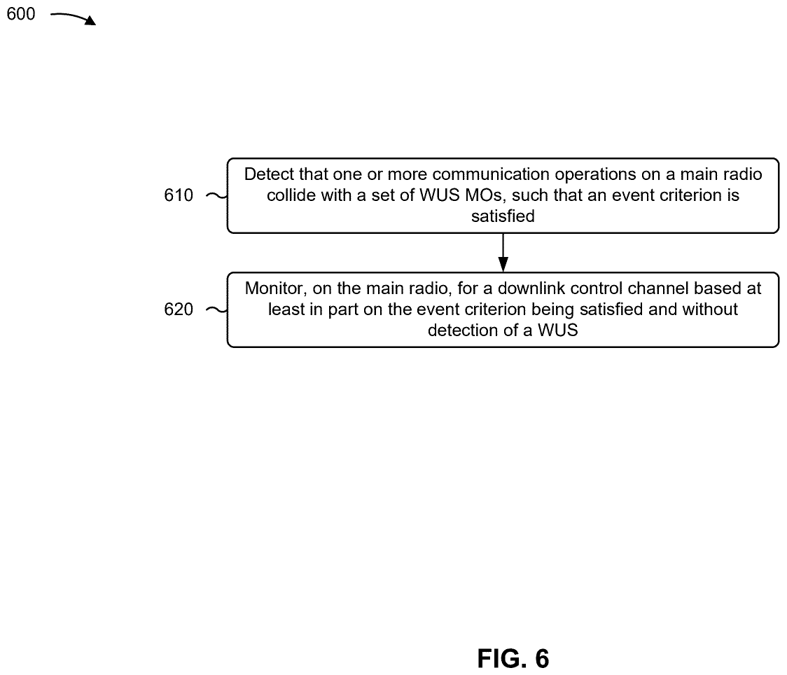

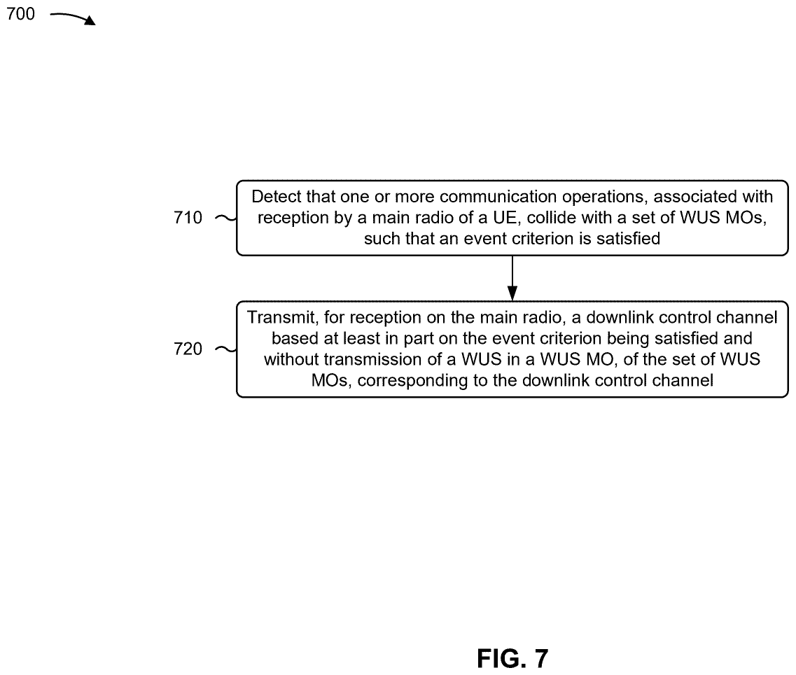

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with LP-WUS monitoring configuration with DRX operations, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

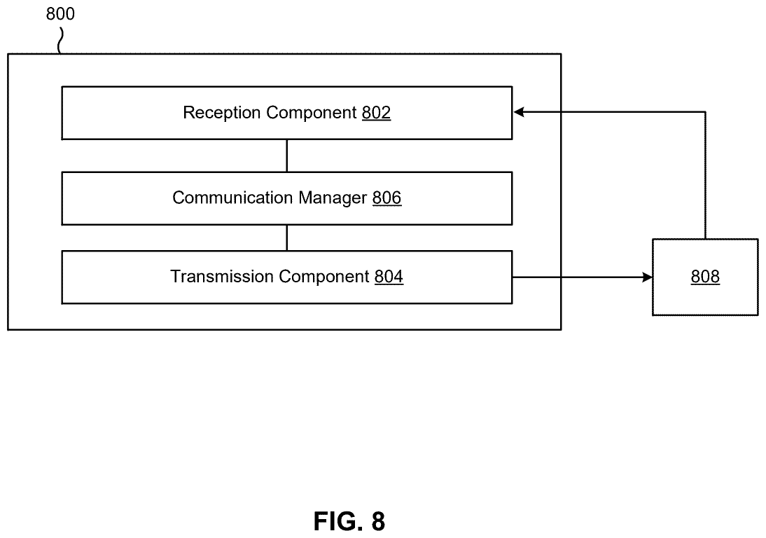

In some aspects, the UE 120 includes means for detecting that one or more communication operations on a main radio collide with a set of WUS MOs, such that an event criterion is satisfied; and/or means for monitoring, on the main radio, for a downlink control channel based at least in part on the event criterion being satisfied and without detection of a WUS. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8 and/or a transmission component (for example, transmission component 804 depicted and described in connection with FIG. 8 among other examples.

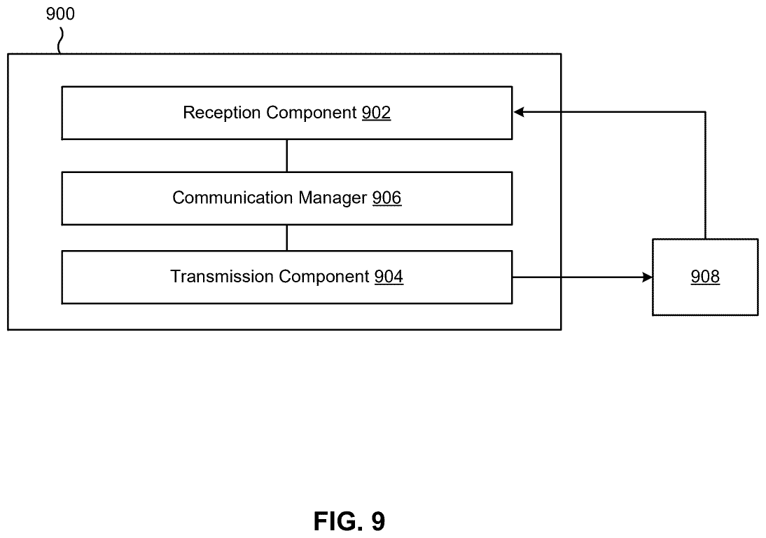

In some aspects, the network node 110 includes means for detecting that one or more communication operations, associated with reception by a main radio of a UE, collide with a set of WUS MOs, such that an event criterion is satisfied; and/or means for transmitting, for reception on the main radio, a downlink control channel based at least in part on the event criterion being satisfied and without transmission of an WUS in a WUS MO, of the set of WUS MOs, corresponding to the downlink control channel. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

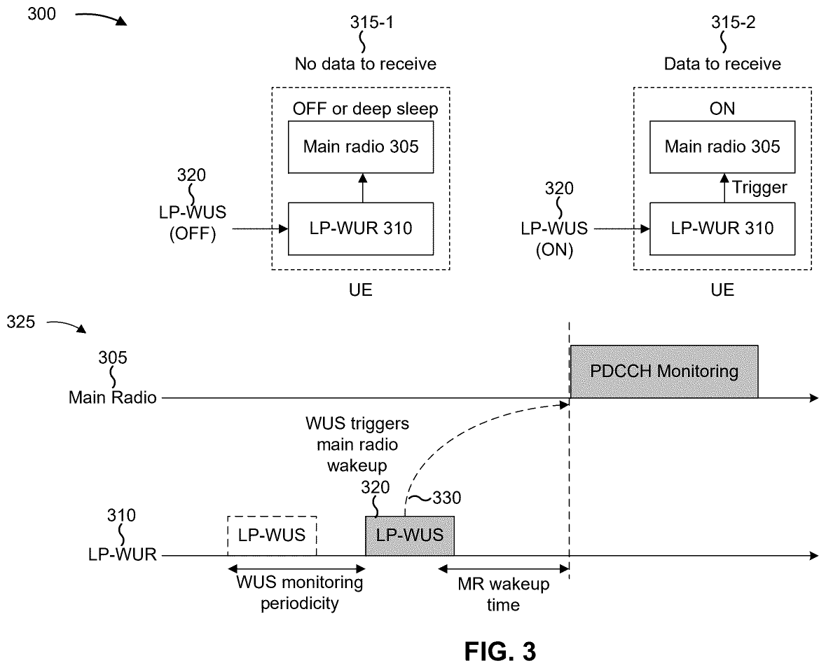

FIG. 3 is a diagram illustrating an example 300 of a WUR (e.g., an LP-WUR) and a WUS (e.g., an LP-WUS), in accordance with the present disclosure. As shown in FIG. 3, a UE (such as UE 120) may be equipped with a communication system that includes a main radio (illustrated as “MR”) 305 and an LP-WUR 310 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 3, the UE may be equipped with the LP-WUR 310, which may be considered a companion receiver that can be used with a main radio 305 to reduce power consumption and latency.

For example, in some examples, the UE may generally use the main radio 305 to transmit and/or receive user data, and the main radio 305 may be turned off or operated in a deep sleep state unless there is user data to transmit and/or receive. Furthermore, the LP-WUR 310 may serve as a simple wakeup receiver for the main radio 305, and the LP-WUR 310 may be active and monitoring for an LP-WUS while the main radio 305 is off or in the deep sleep state. For example, reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 based on detecting the LP-WUS 320. Accordingly, the main radio 305 may then transmit and/or receive user data.

In general, the LP-WUR 310 may consume very little power (for example a target power consumption less than 100 microwatts (μW) in the active state), which may be achieved using simple modulation schemes (for example, on-off keying (OOK)), a narrow bandwidth (for example, less than 5 MHz), and/or other suitable techniques. In this way, the LP-WUR 310 can be used to reduce the time that the main radio 305 spends in an on state and/or may avoid unnecessarily waking the main radio 305 from the off or deep sleep state when there is no user data to transmit or receive, which tends to be costly from a power consumption perspective.

Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor a SS/PBCH block or a low power synchronization signal (LP-SS) for time and frequency tracking and radio resource management (RRM) measurement. In this way, by monitoring the SSB or LP-SS, serving cell and/or neighbor cell monitoring can be offloaded from the main radio 305 to the LP-WUR 310 to reduce how often the main radio 305 is woken up, which can further reduce power consumption.

In some examples, the LP-WUR 310 may include an OOK WUR (also referred to as an envelope detector (ED) WUR). An OOK WUR may only detect the amplitude (such as the magnitude) of a received signal. A UE that uses an OOK WUR may detect the phase of a received signal by activating the MR 305. In some examples, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some examples, as shown by reference number 325, one application of the LP-WUR 310 is to monitor the LP-WUS 320 for paging monitoring, which can be used to reduce unnecessary paging reception performed by the main radio 305. For example, as shown in FIG. 3, the LP-WUR 310 may be configured to monitor for an LP-WUS 320 (while the main radio 305 is off or in a deep sleep state) according to a WUS monitoring periodicity. For example, the LP-WUR 310 may monitor for the LP-WUS 320 in periodic LP-WUS monitoring occasions that are spaced in time according to the WUS monitoring periodicity.

Alternatively, although not explicitly shown in FIG. 3, the LP-WUR 310 may be configured to continuously monitor for the LP-WUS 320. In general, a network node may transmit an LP-WUS 320 to a UE only in cases where there is a paging message that needs to be sent to the UE while the UE is in an idle or inactive state (such as an RRC idle or RRC inactive state). In such cases, as shown by reference number 330, the LP-WUR 310 may receive and detect the LP-WUS 320, which may trigger the LP-WUR 310 to wake up the main radio 305. In some examples, the LP-WUS 320 may be a sequence-based WUS, which may include a predefined set of sequences (implemented, for example, using OOK modulation and/or phase modulation). As shown, the main radio 305 may wake up after a main radio wakeup time, and may then start to monitor one or more synchronization signal block (SSB) transmissions to obtain synchronization with the network node before monitoring and receiving/monitoring the PDCCH in a subsequent time period. Otherwise, in cases where the LP-WUR 310 does not detect the LP-WUS 320, the main radio 305 may remain in the deep sleep state to save power.

As indicated above, FIG. 3 is provided as an example. Other examples may differ from what is described with respect to FIG. 3.

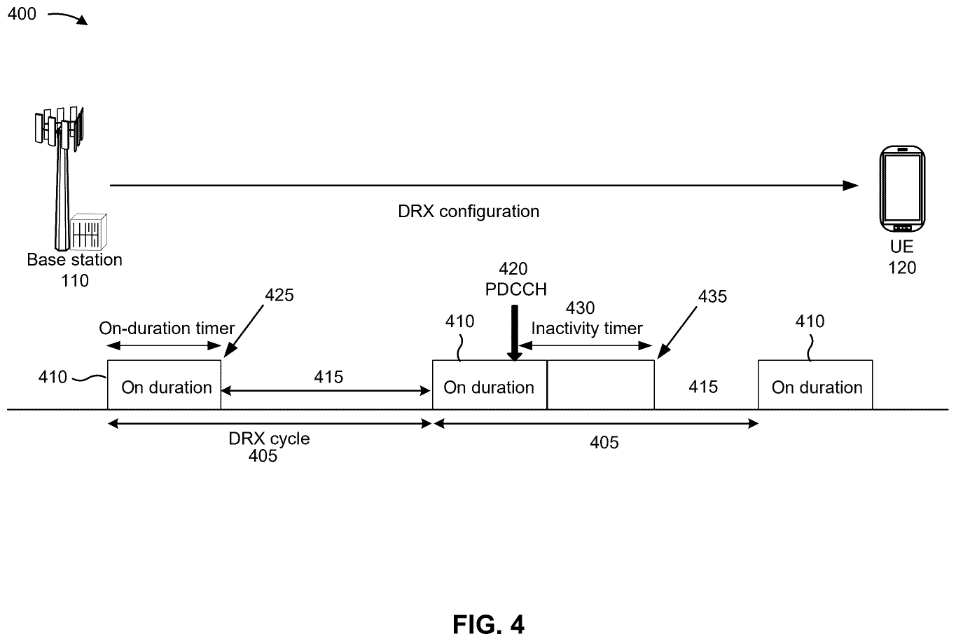

FIG. 4 is a diagram illustrating an example 400 of a discontinuous reception (DRX) configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a physical downlink control channel (PDCCH) during the active time, and may refrain from monitoring the PDCCH during the inactive time.

During the DRX on duration 410 (e.g., the active time), the UE 120 may monitor a downlink control channel (e.g., a PDCCH), as shown by reference number 420. For example, the UE 120 may monitor the PDCCH for downlink control information (DCI) pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435.

During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

As indicated above, FIG. 4 is provided as an example. Other examples may differ from what is described with respect to FIG. 4.

When LP-WUS transmission is used with DRX operations, a UE may monitor for an LP-WUS that triggers the UE to start an on duration timer, such as drx-onDurationTimer, for a DRX cycle. A DRX active time, associated with the on duration timer, may be extended when a condition is satisfied. For example, when the UE receives a PDCCH communication during the DRX active time, the UE may reset an inactivity timer, such as drx-InactivityTimer, and may continue in the DRX active time until the inactivity timer expires. However, when the UE extends the DRX active time, monitoring for PDCCH communications in the DRX active time may collide with (e.g., occur concurrently with) LP-WUS MOs for receiving an LP-WUS associated with triggering a next DRX active time. In other words, the UE may extend a first DRX active time, which may cause the UE to fail to receive an LP-WUS associated with indicating that the UE is to be active for a second DRX active time. This may result in the UE transitioning to a DRX inactive time and failing to receive one or more communications that are directed to the UE.

Various aspects relate generally to LP-WUS monitoring configuration with DRX operations. Some aspects more specifically relate to handling scenarios in which an LP-WUS MO overlaps with another communication operation, such as PDCCH monitoring of a DRX active time. In some aspects, the UE may, when one or more LP-WUS MOs collide with another communication operation, monitor for a PDCCH without having received an LP-WUS associated with triggering monitoring. In other words, when the UE extends a first DRX active time such that PDCCH monitoring in the first DRX active time overlaps with LP-WUS MOs associated with triggering a second DRX active time, the UE may monitor for a PDCCH in the second DRX active time despite not having received an LP-WUS associated with triggering PDCCH monitoring in the second DRX active time. In some aspects, the UE may trigger PDCCH monitoring based on one or more LP-WUS MOs colliding with a measurement gap, a multicast broadcast service (MBS) DRX active time, or a sidelink DRX active time, among other examples. In some aspects, the UE may receive signaling conveying a parameter associated with configuring the UE to perform PDCCH monitoring even when an LP-WUS MO is not received (e.g., as a result of collisions between LP-WUS MOs and another communication operation). For example, the UE may receive signaling indicating a quantity of colliding LP-WUS MOs that the UE may have before triggering PDCCH monitoring. In some aspects, the UE may be configured for PDCCH monitoring during a period scheduled for another communication operation, such as an MBS DRX active time or a sidelink DRX active time (e.g., when one or more LP-WUS MOs collide with other communication operations).

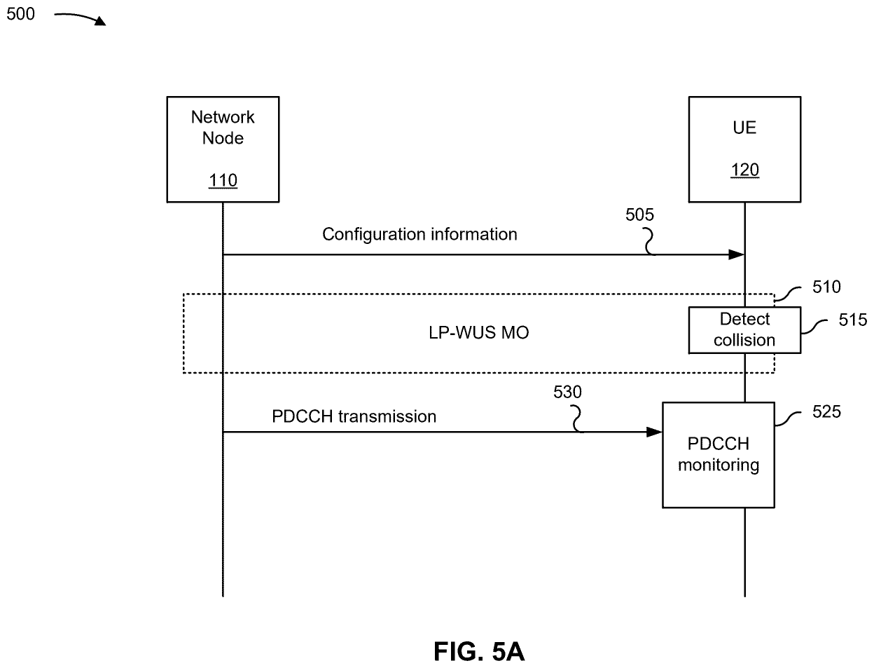

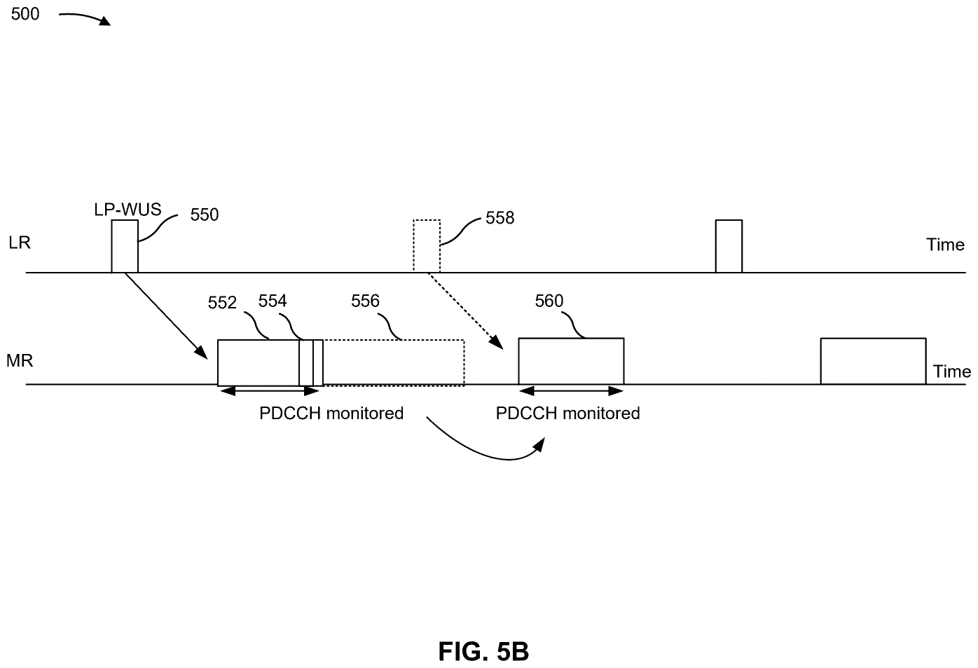

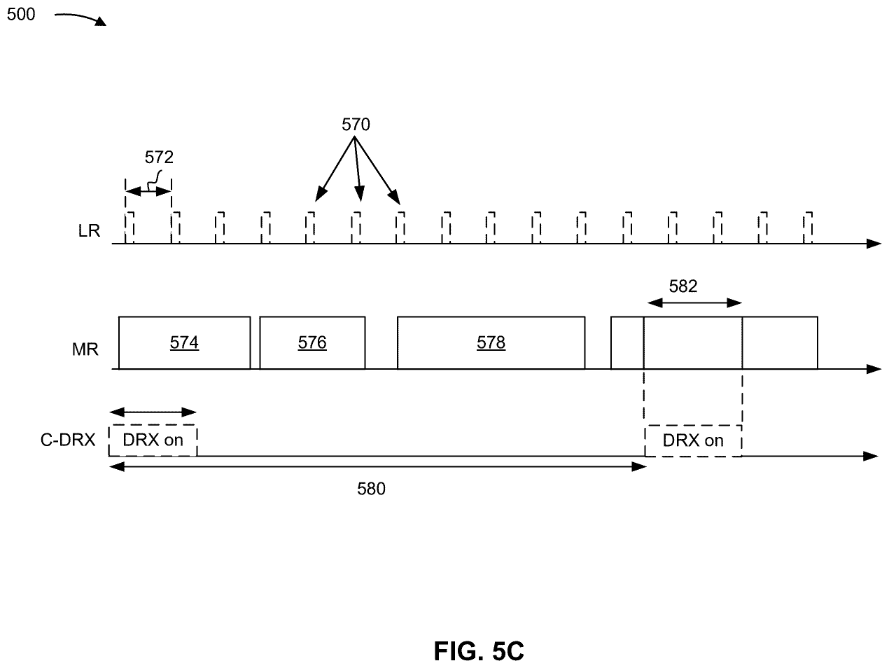

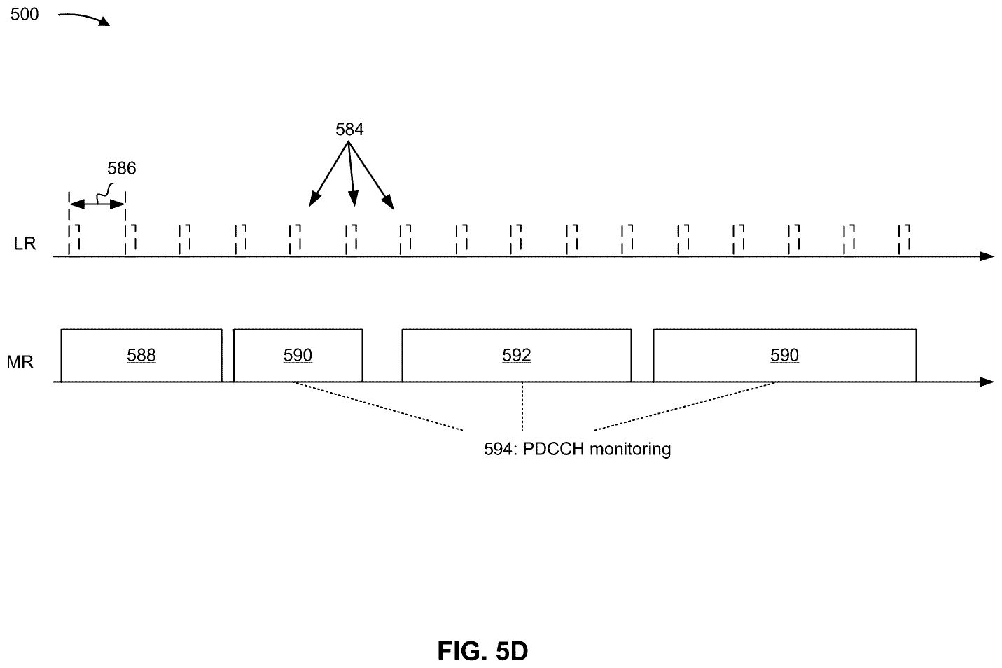

FIGS. 5A-5D are diagrams illustrating examples associated with LP-WUS monitoring configuration with DRX operations, in accordance with the present disclosure. As shown in FIG. 5A, an example 500 includes communication between a network node 110 and a UE 120.

As further shown in FIG. 5A, and by reference number 505, the network node 110 may transmit, and the UE 120 may receive, configuration information. For example, the network node 110 may configure the UE 120 with one or more parameters relating to PDCCH monitoring when an LP-WUS has not been detected (and/or when LP-WUS MOs collide with another communication operation), as described in more detail herein. In some aspects, the UE 120 may receive information identifying an LP-WUS monitoring configuration. For example, the UE 120 may receive information identifying a set of LP-WUS MOs, a set of DRX cycles that correspond to the set of LP-WUS MOs, or another parameter.

In some aspects, the UE 120 may receive configuration information indicating whether to trigger PDCCH monitoring when an LP-WUS has not been detected (e.g., when one or more LP-WUS MOs collide with one or more other communication operations). For example, the UE 120 may receive RRC configuration information indicating whether to trigger PDCCH monitoring based on detection of a collision. Additionally, or alternatively, the UE 120 may receive DCI, a MAC-CE, an information block (e.g., a system information block (SIB) or a master information block (MIB)), or UE assistance information, among other examples. In some aspects, the configuration information may indicate a quantity, N, of LP-WUS MOs that the UE 120 can drop and still monitor a PDCCH. In other words, when the UE 120 detects a collision for N LP-WUS MOs (and does not monitor the colliding LP-WUS MOs), the UE 120 may trigger PDCCH monitoring. In some aspects, the N LP-WUS MOs may be configured to be consecutive LP-WUS MOs or non-consecutive LP-WUS MOs within a particular time period. Additionally, or alternatively, the UE 120 may receive a configuration of a maximum duration for non-PDCCH monitoring. For example, if the UE 120 does not monitor a PDCCH (e.g., due to not receiving an LP-WUS indication) for a threshold period of time, the UE 120 may be configured to trigger PDCCH monitoring.

As further shown in FIG. 5A, and by reference numbers 510 and 515, the UE 120 may detect a collision associated with an LP-WUS MO. For example, the UE 120 may determine that an LP-WUS MO is scheduled for first resources concurrent with second resources that are scheduled for another communication operation, such as PDCCH monitoring. In other words, the UE 120 may determine that first PDCCH monitoring, associated with a first LP-WUS, overlaps with an MO for detecting a second LP-WUS that is to trigger second PDCCH monitoring. In some aspects, one or more LP-WUS MOs, for which a collision is detected, may be associated with a DRX cycle. For example, LP-WUS monitoring may occur, in accordance with an LP-WUS monitoring configuration, before a DRX on duration timer is started and to trigger starting of the DRX on duration timer. In some aspects, the UE 120 may detect a collision for an LP-WUS MO in a DRX active time. Additionally, or alternatively, the UE 120 may detect a collision for an LP-WUS MO not within a DRX active time. For example, the UE 120 may be configured with LP-WUS MOs within a long cycle DRX and offset from PDCCH monitoring by a threshold time gap.

As further shown in FIG. 5A, and by reference numbers 525 and 530, the UE 120 may perform PDCCH monitoring and may receive a PDCCH transmission from the network node 110. For example, the UE 120 may perform PDCCH monitoring based on detecting a collision associated with an LP-WUS MO. Additionally, or alternatively, the UE 120 may perform PDCCH monitoring without having received an LP-WUS.

In some aspects, the UE 120 may perform PDCCH monitoring based on a quantity of LP-WUS MOs not being able to be monitored as a result of one or more other communication activities. For example, when one or more (or all) valid LP-WUS MOs for a current DRX cycle cannot be monitored based on another communication operation, the UE 120 may start a DRX on duration timer for the current DRX cycle (and perform PDCCH monitoring) even though the UE 120 has not received an LP-WUS that triggers the start of the DRX on duration timer for the current DRX cycle. As shown in FIG. 5B, the UE 120 may detect an LP-WUS 550, on an LP-WUR (shown as “LR”) that triggers a PDCCH monitoring period 552 on a main radio (shown as “MR”). During the PDCCH monitoring period 552, the UE 120 may detect a communication 554 (e.g., a PDCCH communication) that extends the PDCCH monitoring period 552 for a duration 556. The duration 556 may overlap with an LP-WUS MO 558 that is associated with a next PDCCH monitoring period 560. In this case, based on the LP-WUS MO 558 colliding with the duration 556 (e.g., during which the UE 120 is performing PDCCH monitoring rather than LP-WUS monitoring), the UE 120 may determine to perform PDCCH monitoring in PDCCH monitoring period 560 (without having received an LP-WUS in LP-WUS MO 558).

In some aspects, the other communication operation may include a DRX active time associated with a previous DRX cycle (e.g., which, when extended, may overlap with the LP-WUS MOs for the current DRX cycle). Additionally, or alternatively, the other communication operation may include a measurement gap that overlaps with the LP-WUS MOs for the current DRX cycle. Additionally, or alternatively, the other communication operation may include an active time associated with an MBS DRX cycle or sidelink (SL) DRX cycle. As shown in FIG. 5C, the UE 120 may be configured with a set of LP-WUS MOs 570 with an LP-WUS MO periodicity 572. The UE 120 may be configured with a set of communication operations, such as a measurement gap 574, an MBS DRX active time 576, and an SL DRX active time 578. In this case, each LP-WUS MO 570 collides with another communication operation, as shown, for a period 580 associated with a long DRX cycle. Accordingly, the UE 120 may start a DRX on duration timer and perform PDCCH monitoring for a DRX on duration timer period 582, based on there not being any LP-WUS MOs that the UE 120 can monitor during the period 580 (e.g., between a previous DRX on duration timer period and the current DRX on duration timer period 582). In some aspects, the UE 120 may start PDCCH monitoring based on a threshold quantity or percentage of LP-WUS MOs colliding with other communication operations. For example, the UE 120 may be configured with a threshold percentage of LP-WUSs between DRX on duration timer periods that, when determined to collide with other communication operations, trigger PDCCH monitoring without detection of an LP-WUS. In some aspects, the UE 120 may start PDCCH monitoring based on a single LP-WUS MO colliding with other communication operations.

In some aspects, the UE 120 may perform PDCCH monitoring concurrently with another communication operation. For example, when a UE 120 is configured with an MBS DRX cycle or an SL DRX cycle, the UE 120 may monitor for a PDCCH (e.g., with a cell-specific radio network temporary identifier (C-RNTI)) during an MBS DRX active time or an SL DRX active time. In this case, the UE 120 may monitor the PDCCH concurrently with the other communication operation based on the UE 120 being configured for LP-WUS monitoring, the UE 120 being configured with LP-WUSs that are offset from PDCCH monitoring periods, the UE 120 detecting a collision between an LP-WUS MO and another communication operation, or a combination thereof, among other examples. For example, as shown in FIG. 5D, the UE 120 may be configured with a set of LP-WUS MOs 584 with an LP-WUS MO periodicity 586. The UE 120 may be configured with a set of communication operations, such as a measurement gap 588, a set of MBS DRX active times 590, and an SL DRX active time 592. In this case, each LP-WUS MO 584 collides with another communication operation, as shown. Accordingly, the UE 120 may monitor a PDCCH during the MBS DRX active times 590 or the SL DRX active time 592, as shown by reference number 594.

As indicated above, FIGS. 5A-5D are provided as an example. Other examples may differ from what is described with respect to FIGS. 5A-5D.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with WUS monitoring configuration with discontinuous reception operations.

As shown in FIG. 6, in some aspects, process 600 may include detecting that one or more communication operations on a main radio collide with a set of WUS MOs, such that an event criterion is satisfied (block 610). For example, the UE (e.g., using communication manager 806, depicted in FIG. 8) may detect that one or more communication operations on a main radio collide with a set of WUS MOs, such that an event criterion is satisfied, as described above.

As further shown in FIG. 6, in some aspects, process 600 may include monitoring, on the main radio, for a downlink control channel based at least in part on the event criterion being satisfied and without detection of a WUS (block 620). For example, the UE (e.g., using communication manager 806, depicted in FIG. 8) may monitor, on the main radio, for a downlink control channel based at least in part on the event criterion being satisfied and without detection of a WUS, as described above.

Process 600 may include additional aspects, such as any single aspect or any combination of aspects described below and/or in connection with one or more other processes described elsewhere herein.

In a first aspect, the set of WUS MOs is associated with a WUR.

In a second aspect, alone or in combination with the first aspect, the event criterion is related to at least one of a configured time period elapsing, or a quantity of collisions between the one or more communication operations and the set of WUS MOs.

In a third aspect, alone or in combination with one or more of the first and second aspects, the event criterion is related to a connected discontinuous reception cycle.

In a fourth aspect, alone or in combination with one or more of the first through third aspects, the monitoring for the downlink control channel is associated with a discontinuous reception on duration timer that is started based on the event criterion being satisfied and without detection of the WUS.

In a fifth aspect, alone or in combination with one or more of the first through fourth aspects, process 600 includes detecting the WUS on a WUR in an MO, and monitoring, on the main radio, for the downlink control channel based on detecting the WUS on the WUR in the MO.

In a sixth aspect, alone or in combination with one or more of the first through fifth aspects, process 600 includes detecting the WUS on a WUR in an MO, and skipping monitoring, on the main radio, for the downlink control channel after detecting the WUS on the WUR in the MO based on a downlink channel monitoring skipping configuration.

In a seventh aspect, alone or in combination with one or more of the first through sixth aspects, the UE is scheduled with a multicast-broadcast discontinuous reception communication operation or a sidelink discontinuous reception communication operation, and the UE is configured to perform downlink channel monitoring during the multicast-broadcast discontinuous reception communication operation or the sidelink discontinuous reception communication operation based at least in part on a configuration of the UE for WUS monitoring.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with WUS monitoring configuration with discontinuous reception operations.

As shown in FIG. 7, in some aspects, process 700 may include detecting that one or more communication operations, associated with reception by a main radio of a UE, collide with a set of WUS MOs, such that an event criterion is satisfied (block 710). For example, the network node (e.g., using communication manager 906, depicted in FIG. 9) may detect that one or more communication operations, associated with reception by a main radio of a UE, collide with a set of WUS MOs, such that an event criterion is satisfied, as described above.

As further shown in FIG. 7, in some aspects, process 700 may include transmitting, for reception on the main radio, a downlink control channel based at least in part on the event criterion being satisfied and without transmission of a WUS in a WUS MO, of the set of WUS MOs, corresponding to the downlink control channel (block 720). For example, the network node (e.g., using transmission component 904 and/or communication manager 906, depicted in FIG. 9) may transmit, for reception on the main radio, a downlink control channel based at least in part on the event criterion being satisfied and without transmission of a WUS in a WUS MO, of the set of WUS MOs, corresponding to the downlink control channel, as described above.

Process 700 may include additional aspects, such as any single aspect or any combination of aspects described below and/or in connection with one or more other processes described elsewhere herein.

In a first aspect, the set of WUS MOs is associated with a WUR.

In a second aspect, alone or in combination with the first aspect, the event criterion is related to at least one of a configured time period elapsing, or a quantity of collisions between the one or more communication operations and the set of WUS MOs.

In a third aspect, alone or in combination with one or more of the first and second aspects, the event criterion is related to a connected discontinuous reception cycle.

In a fourth aspect, alone or in combination with one or more of the first through third aspects, the monitoring for the downlink control channel is associated with a discontinuous reception on duration timer that is started based on the event criterion being satisfied and without detection of the WUS.

In a fifth aspect, alone or in combination with one or more of the first through fourth aspects, process 700 includes transmitting the WUS, and transmitting, based on transmitting the WUS, the downlink control channel.

In a sixth aspect, alone or in combination with one or more of the first through fifth aspects, process 700 includes transmitting the WUS, and skipping transmission of the downlink control channel based on a downlink channel monitoring skipping configuration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 5A-5D. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may detect that one or more communication operations on a main radio collide with a set of WUS MOs, such that an event criterion is satisfied. The communication manager 806 may monitor, on the main radio, for a downlink control channel based at least in part on the event criterion being satisfied and without detection of a WUS.

The communication manager 806 may detect the WUS on a WUR in an MO. The communication manager 806 may monitor, on the main radio, for the downlink control channel based on detecting the WUS on the WUR in the MO. The communication manager 806 may detect the WUS on a WUR in an MO. The communication manager 806 may skip monitoring, on the main radio, for the downlink control channel after detecting the WUS on the WUR in the MO based on a downlink channel monitoring skipping configuration.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 5A-5D. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may detect that one or more communication operations, associated with reception by a main radio of a UE, collide with a set of WUS MOs, such that an event criterion is satisfied. The transmission component 904 may transmit, for reception on the main radio, a downlink control channel based at least in part on the event criterion being satisfied and without transmission of a WUS in a WUS MO, of the set of WUS MOs, corresponding to the downlink control channel.

The transmission component 904 may transmit the WUS. The transmission component 904 may transmit, based on transmitting the WUS, the downlink control channel. The transmission component 904 may transmit the WUS. The communication manager 906 may skip transmission of the downlink control channel based on a downlink channel monitoring skipping configuration.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: detecting that one or more communication operations on a main radio collide with a set of wake-up signal (WUS) monitoring occasions (MOs), such that an event criterion is satisfied; and monitoring, on the main radio, for a downlink control channel based at least in part on the event criterion being satisfied and without detection of a WUS.

Aspect 2: The method of Aspect 1, wherein the set of WUS MOs is associated with a wake-up radio (WUR).

Aspect 3: The method of any of Aspects 1-2, wherein the event criterion is related to at least one of: a configured time period elapsing, or a quantity of collisions between the one or more communication operations and the set of WUS MOs.

Aspect 4: The method of any of Aspects 1-3, wherein the event criterion is related to a connected discontinuous reception cycle.

Aspect 5: The method of any of Aspects 1-4, wherein the monitoring for the downlink control channel is associated with a discontinuous reception on duration timer that is started based on the event criterion being satisfied and without detection of the WUS Aspect 6: The method of any of Aspects 1-5, further comprising: detecting the WUS on a wake-up radio (WUR) in an MO; and monitoring, on the main radio, for the downlink control channel based on detecting the WUS on the WUR in the MO.

Aspect 7: The method of any of Aspects 1-6, further comprising: detecting the WUS on a wake-up radio (WUR) in an MO; and skipping monitoring, on the main radio, for the downlink control channel after detecting the WUS on the WUR in the MO based on a downlink channel monitoring skipping configuration.

Aspect 8: The method of any of Aspects 1-7, wherein the UE is scheduled with a multicast-broadcast discontinuous reception communication operation or a sidelink discontinuous reception communication operation, and wherein the UE is configured to perform downlink channel monitoring during the multicast-broadcast discontinuous reception communication operation or the sidelink discontinuous reception communication operation based at least in part on a configuration of the UE for WUS monitoring.

Aspect 9: A method of wireless communication performed by a network node, comprising: detecting that one or more communication operations, associated with reception by a main radio of a user equipment (UE), collide with a set of wake-up signal (WUS) monitoring occasions (MOs), such that an event criterion is satisfied; and transmitting, for reception on the main radio, a downlink control channel based at least in part on the event criterion being satisfied and without transmission of a WUS in a WUS MO, of the set of WUS MOs, corresponding to the downlink control channel.

Aspect 10: The method of Aspect 9, wherein the set of WUS MOs is associated with a wake-up radio (WUR).

Aspect 11: The method of any of Aspects 9-10, wherein the event criterion is related to at least one of: a configured time period elapsing, or a quantity of collisions between the one or more communication operations and the set of WUS MOs.

Aspect 12: The method of any of Aspects 9-11, wherein the event criterion is related to a connected discontinuous reception cycle.

Aspect 13: The method of any of Aspects 9-12, wherein the monitoring for the downlink control channel is associated with a discontinuous reception on duration timer that is started based on the event criterion being satisfied and without detection of the WUS Aspect 14: The method of any of Aspects 9-13, further comprising: transmitting the WUS; and transmitting, based on transmitting the WUS, the downlink control channel.

Aspect 15: The method of any of Aspects 9-14, further comprising: transmitting the WUS; and skipping transmission of the downlink control channel based on a downlink channel monitoring skipping configuration.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
detect that one or more communication operations on a main radio collide with a set of wake-up signal (WUS) monitoring occasions (MOs), such that an event criterion is satisfied; and
monitor, on the main radio, for a downlink control channel based at least in part on the event criterion being satisfied and without detection of a WUS.

2. The UE of claim 1, wherein the set of WUS MOs is associated with a wake-up radio (WUR).

3. The UE of claim 1, wherein the event criterion is related to at least one of:
a configured time period elapsing, or
a quantity of collisions between the one or more communication operations and the set of WUS MOs.

4. The UE of claim 1, wherein the event criterion is related to a connected discontinuous reception cycle.

5. The UE of claim 1, wherein the monitoring for the downlink control channel is associated with a discontinuous reception on duration timer that is started based on the event criterion being satisfied and without detection of the WUS.

6. The UE of claim 1, wherein the one or more processors are further configured to cause the UE to:
detect the WUS on a wake-up radio (WUR) in an MO; and
monitor, on the main radio, for the downlink control channel based on detecting the WUS on the WUR in the MO.

7. The UE of claim 1, wherein the one or more processors are further configured to cause the UE to:
detect the WUS on a wake-up radio (WUR) in an MO; and
skip monitoring, on the main radio, for the downlink control channel after detecting the WUS on the WUR in the MO based on a downlink channel monitoring skipping configuration.

8. The UE of claim 1, wherein the UE is scheduled with a multicast-broadcast discontinuous reception communication operation or a sidelink discontinuous reception communication operation, and
wherein the UE is configured to perform downlink channel monitoring during the multicast-broadcast discontinuous reception communication operation or the sidelink discontinuous reception communication operation based at least in part on a configuration of the UE for WUS monitoring.

9. A network node for wireless communication, comprising:
one or more memories; and
one or more processors, coupled to the one or more memories, configured to cause the network node to:
detect that one or more communication operations, associated with reception by a main radio of a user equipment (UE), collide with a set of wake-up signal (WUS) monitoring occasions (MOs), such that an event criterion is satisfied; and
transmit, for reception on the main radio, a downlink control channel based at least in part on the event criterion being satisfied and without transmission of a WUS in a WUS MO, of the set of WUS MOs, corresponding to the downlink control channel.

10. The network node of claim 9, wherein the set of WUS MOs is associated with a wake-up radio (WUR).

11. The network node of claim 9, wherein the event criterion is related to at least one of:
a configured time period elapsing, or
a quantity of collisions between the one or more communication operations and the set of WUS MOs.

12. The network node of claim 9, wherein the event criterion is related to a connected discontinuous reception cycle.

13. The network node of claim 9, wherein the monitoring for the downlink control channel is associated with a discontinuous reception on duration timer that is started based on the event criterion being satisfied and without detection of the WUS.

14. The network node of claim 9, wherein the one or more processors are further configured to cause the network node to:
transmit the WUS; and
transmit, based on transmitting the WUS, the downlink control channel.

15. The network node of claim 9, wherein the one or more processors are further configured to cause the network node to:
transmit the WUS; and
skip transmission of the downlink control channel based on a downlink channel monitoring skipping configuration.

16. A method of wireless communication performed by a user equipment (UE), comprising:
detecting that one or more communication operations on a main radio collide with a set of wake-up signal (WUS) monitoring occasions (MOs), such that an event criterion is satisfied; and
monitoring, on the main radio, for a downlink control channel based at least in part on the event criterion being satisfied and without detection of a WUS.

17. The method of claim 16, wherein the set of WUS MOs is associated with a wake-up radio (WUR).

18. The method of claim 16, wherein the event criterion is related to at least one of:
a configured time period elapsing, or
a quantity of collisions between the one or more communication operations and the set of WUS MOs.

19. The method of claim 16, wherein the event criterion is related to a connected discontinuous reception cycle.

20. The method of claim 16, wherein the monitoring for the downlink control channel is associated with a discontinuous reception on duration timer that is started based on the event criterion being satisfied and without detection of the WUS.
